(19) United States
(12) Patent Application Publication
(10) Pub. No.: US 2015/0018073 A1
(43) Pub. Date: Jan. 15, 2015

(54) Fantasy gaming

(71) Applicants: Travis William Carrico, Watertown, SD (US); Neil J. Matthiesen, Sioux Falls, SD (US)

(72) Inventors: Travis William Carrico, Watertown, SD (US); Neil J. Matthiesen, Sioux Falls, SD (US)

(21) Appl. No.: 13/987,183

(22) Filed: Jul. 9, 2013

(51) Int. Cl. G07F 17/32

(52) U.S. Cl. CPC G07F 17/3288
USPC 463/25

(57) ABSTRACT

A fantasy gaming system or method is disclosed in which persons may wager on the performance of players in a team sport in games which occurs at a known time in the future.

This application relies for priority upon the provisional application filed by Travis Carrico and Neil Matthiesen on Jul. 10, 2012, Ser. No. 61/741,009.

### BACKGROUND OF THE INVENTION

1. Field of the Invention

The present invention relates generally to gaming and more specifically to a type of gaming based upon fantasy sports games.

2. Background Information

For many years a great number of people have engaged in playing fantasy sports games. Although the rules and practices of such games vary; in general, a group of participants forms what is often called a league and each participant “drafts” a different team of real players in some sport. In a fantasy football league, each player might draft two or three players at the positions of quarterback, running back, and wide receiver. In order to bring some elements of defense into the fantasy game, in many leagues participants also select one or two teams to serve as a defense. Typically, each participant will pick a team consisting of one quarterback, one running back, one wide receiver, and a defense. Two participants typically play against each other each week in football and on some other basis for other sports.

A participant's score is based upon the performance of the fantasy players on the participant's team in the real world. For example, a running back might get six points for each touchdown scored and one point for each ten yards gained rushing. Each participant's score is determined based upon the real world success of fantasy players and, of course, the participant with the highest team score wins. Although rules and scoring vary widely between leagues and sports, participant scoring is nearly always determined by the performance in the real world of players picked for a fantasy team. Most often, there is some form of “entry fee” to play in a fantasy league, and participants divide up a pot of money at the end of the season based upon how well a fantasy team did in the real world.

The extreme popularity of fantasy sports leagues indicates a probability that persons who play fantasy sports would be very interested in fantasy gaming in which wagers could be made upon the performance of a fantasy team or number of players in the real world.

The fantasy gaming process or method of the instant invention solves the above problems by providing a method or process of wagering upon the performance of a selected fantasy team. The ideal fantasy gaming process or method should also be based upon actions or occurrences which happen in the real world. The ideal fantasy gaming process or method should also be simple and easy to operate and maintain.

### SUMMARY OF THE INVENTION

The fantasy gaming of the instant invention provides a process or method by which participants may wager on the performance of a group of fantasy players selected by a participant where winning depends upon the performance of the fantasy players selected in the real world.

In the simplest embodiment, a participant pays a fee (or places a wager) to participate and would select a quarterback, a running back, and a wide receiver. All potential players at these positions would be rated based upon their performance in a preselected slate of games. For football, for example, the most convenient slate of games would probably be all the games which occur in a particular week. Methods of evaluating real world performance would be established prior to accepting any fees or wagers for the week. Each player would receive a score based upon performance. Various payouts would be calculated based upon the predetermined odds for any particular player at any particular position largely based upon past performance.

The payout is based solely upon getting the right (highest scoring) players at each position. For example, a participant picking the top scorer correctly at all three positions might receive a 100 to 1 payout or $100 for each $1 wagered. A participant picking the top scorer at two out of three positions might receive a 5 to 1 payout or $5 for each $1 wagered. As may be seen, there are a variety of possibilities with this embodiment. For example, rather than picking 3 players, a number of players other than 3 could be picked. In general, the more players picked, the higher the payout. Picking the top player at four different positions might result in a payout of 1000 to 1 rather than 100 to 1.

In a second embodiment, payouts would be determined prior to participants making their selections based upon previous performances of the players. For example, quarterbacks would be rated from the one most likely to score a lot of quarterback points to the one least likely to score a lot of points. Payouts would be based upon whether the quarterback (or other player) was previously judged to be likely to score a lot of points or not. For example, if a participant picked the top ranked quarterback, running back, and wide receiver and won, the payout might be 50 to 1. That is, if the participant wagered one dollar, she would win fifty dollars. If the participant picked players in the mid-rank and picked the top scorer at all three positions for the week, the payout would be much higher, for instance, a one dollar wager might pay back $250.

Gaming based upon the occurrence of multiple events rather than upon a single event is most often referred to as “Parlay” wagering. In an ordinary wager, for example, a person would bet upon a single team to win and winning or losing depends upon which team wins a single game. In a parlay, a person would wager on more games than one. That is, a person would wager on two or more teams winning. In nearly every case, the more games selected in a wager, the higher the payout.

As may be seen, the same method could be applied to a variety of activities which are not sports related. Nearly anything in which a fantasy element may be compared to a real world result could be used. For example, a fantasy stock market could be established in which participants would wager upon the future movement of stocks without actually buying the stock. A participant might wager that Apple would go up 60 points in the next two weeks and that Microsoft would go down 20 points. A one dollar wager might have a 500 to 1 payout. The participant could also wager that a slate of x number of stock would all go up or down.

One of the major objects of the present invention is to provide a method or process of wagering upon the performance of a selected fantasy team based upon the real world performance of the fantasy team.

Another objective of the present invention is to provide a fantasy gaming process or method based upon actions or occurrences which happen in the real world.

Another objective of the present invention is to provide a fantasy gaming method or process which is simple, reliable, and easy to use.

These and other features of the invention will become apparent when taken in consideration with the following detailed description.

### BRIEF DESCRIPTION OF THE DRAWINGS

No drawings are provided.

### DESCRIPTION OF A PREFERRED EMBODIMENT

The fantasy gaming process or method of the instant invention is described below as being applied to professional football games, but could easily be applied to a wide variety of other sports and activities. The instant invention could be applied to any activity in which there is a pool of occurrences or actions which are easily identifiable and in which past and current performance may be readily measured.

In the preferred embodiment of the instant invention, a weekly slate of professional football games is used to illustrate the instant invention; but other sports or activities could be used. Persons may wager in any of the conventional ways including at a casino or online. The operator produces a fantasy parlay card which may be either physical or digital and which lists the players most likely to play at various positions for all professional football teams. In the following illustration, quarterbacks, running backs, wide receivers, and kickers are listed, but any number of player positions greater than one could be used. A typical parlay card is shown below.

Fantasy Parlay Card 1

| Quarterback | | Running Back | | Wide Receiver | | Kicker | |
|---|---|---|---|---|---|---|---|
| Tom Brady | | Adrian Peterson | ✓ | Calvin Johnson | | Matt Bryant | |
| Payton Manning | | Arian Foster | | Dez Bryant | | Matt Prater | |
| Cam Newton | | LeSean McCoy | | Brandon Marshall | | Blair Walsh | |
| Mike Vick | ✓ | Ray Rice | | A. J. Green | | Justin Tucker | |
| Kevin Kolb | | Doug Martin | | Julio Jones | | Dan Bailey | |
| Jake Locker | | Jamaal Charles | | Percy Harvin | | Lawrence Tynes | |
| Drew Brees | | C. J. Spiller | | Randall Cobb | ✓ | Greg Zuerlein | |
| Vince Young | | Trent Richardson | | Vincent Jackson | | Steven Hauschka | |
| Alex Smith | | Alfred Morris | | Andre Johnson | | Connor Barth | |
| Andrew Luck | | Matt Forte | | Larry Fitzgerald | | Randy Bullock | |
| Tim Tebow | | Chris Johnson | | Roddie White | | Mason Crosby | |
| Jay Cutler | | DeMarco Murray | | Victor Cruz | | David Akers | |
| Aaron Rogers | | Frank Gore | | Reggie Wayne | | Garrett Hartley | |
| Tony Romo | | Reggie Bush | | Hakeem Nicks | | Josh Brown | |
| Joe Flacco | | Chris Ivory | | Jordy Nelson | | Adam Vinatieri | |
| Andy Dalton | | Darren Sproles | | Mike Wallace | | Phil Dawson | |
| Matt Ryan | | Montee Ball | | Pierre Garcon | | Alex Henery | ✓ |
| Eli Manning | | Ryan Mathews | | Eric Decker | | Rob Bironas | |
| Russell Wilson | | Lamar Miller | | Wes Welker | | Kai Forbath | |
| Matt Schaub | | Mikel Leshoure | | Steve Smith | | Mike Nugent | |
| Carson Palmer | | Vick Ballard | | Dwayne Bowe | | Jay Feely | |
| Dennis Dixon | | Eddie Lacy | | Torrey Smith | | Nick Novak | |
| Geno Smith | | Mark Ingram | | Greg Jennings | | Dan Carpenter | |
| | | Fred Jackson | | Cecil Shorts | | Billy Cundiff | |
| | | Ryan Williams | | Steve Johnson | | | |
| | | Michael Turner | | Antonio Brown | | | |
| | | Michael Bush | | Miles Austin | | | |
| | | Steven Jackson | | Mike Williams | | | |
| | | Ben Tate | | Josh Gordon | | | |
| | | Isaiah Pead | | DeSean Jackson | | | |
| | | | | Jeremy Maclin | | | |
| | | | | T. Y. Hilton | | | |

Bet Type: 4 Person Parlay
Wager: $1
Sport: Football
Time Period: Week 3
Payout: 4 of 4 = $1000, 3 of 4 = $100, 2 of 4 = $10,
Choose one player from each category ✓

In the above instance, the person making the wager has selected a quarterback, a running back, a wide receiver, and a kicker. The above parlay card also indicates that the payouts for various outcomes have been predetermined. For a one dollar wager, a person would receive $1,000 if he picked the correct quarterback, running back, wide receiver, and kicker; $100 for picking 3 out of 4, and $10 for picking 2 out of 4. As may be seen this example is for the third week of the professional football season.

The performance of each player is evaluated for the third week performance based on preset criteria. A quarterback, for example, would get one point for each twenty five yards passing and six points for each touchdown thrown. The quarterback with the most points for the week is the “winning” quarterback and persons who selected that quarterback in their parlay card would score a quarterback win. Similar criteria are established for each of the positions. For example, running backs score six points for scoring a touchdown and one point for each ten yards rushing; wide receivers score six points for scoring a touchdown and one point for each ten yards receiving; and kickers score 3 points for each field goal and 1 point for each extra point.

Payouts are calculated in a conventional manner with the amount which may be won increasing as the odds against winning increase. Contrary to conventional fantasy sports play, persons using the fantasy gaming of the instant invention are not competing with other individuals playing the same game. A person's payout is not affected by the result of other individuals playing the same game.

In a second embodiment of the instant invention, payouts are based, at least in part, upon the past performance of the football players. This embodiment is illustrated in Fantasy Parlay Card 2 set out below. Game play is identical to that described above, but the payout is based, in part, upon how well a player has performed in the past. For instance, a quarterback who is leading the league in passing yards and touchdowns would be considered more likely to win the quarterback slot than a quarterback who is tenth in the league in passing yards and fifteenth in touchdowns. The odds against a particular quarterback scoring the most quarterback points for a particular week are determined in a conventional manner, much the same way in which odds are determined in a horse race. Similarly, a running back who is leading the league in rushing and third in touchdowns would be considered more likely to score the most running back points than a running back who is fifth in the league in rushing yards and seventh in touchdowns scored. The relative odds of the various players winning a particular weeks scoring are determined and incorporated into the parlay card as shown below. In this example, the odds of Payton Manning scoring the most points as a quarterback are 4 to 1 while the odds of Tony Romo are 15 to 1. According to these odds, Payton Manning has a much better chance of scoring more quarterback points for the week than Tony Romo.

Fantasy Parlay Card 2

| Quarterback | | | Running Back | | | Wide Receiver | | |
|---|---|---|---|---|---|---|---|---|
| Tom Brady | 4 to 1 | | Adrian Peterson | 6 to 1 | ✓ | Calvin Johnson | 2 to 1 | |
| Payton Manning | 4 to 1 | | Arian Foster | 6 to 1 | | Dez Bryant | 4 to 1 | |
| Cam Newton | 6 to 1 | | LeSean McCoy | 6 to 1 | | Brandon Marshall | 4 to 1 | |
| Mike Vick | 10 to 1 | ✓ | Ray Rice | 6 to 1 | | A. J. Green | 4 to 1 | |
| Kevin Kolb | 10 to 1 | | Doug Martin | 6 to 1 | | Julio Jones | 4 to 1 | |
| Jake Locker | 10 to 1 | | Jamaal Charles | 6 to 1 | | Percy Harvin | 6 to 1 | |
| Drew Brees | 10 to 1 | | C. J. Spiller | 8 to 1 | | Randall Cobb | 6 to 1 | |
| Vince Young | 12 to 1 | | Trent Richardson | 8 to 1 | | Vincent Jackson | 6 to 1 | |
| Alex Smith | 12 to 1 | | Alfred Morris | 8 to 1 | | Andre Johnson | 6 to 1 | |
| Andrew Luck | 12 to 1 | | Matt Forte | 8 to 1 | | Larry Fitzgerald | 8 to 1 | |
| Tim Tebow | 15 to 1 | | Chris Johnson | 8 to 1 | | Roddie White | 8 to 1 | |
| Jay Cutler | 15 to 1 | | DeMarco Murray | 8 to 1 | | Victor Cruz | 8 to 1 | |
| Aaron Rogers | 15 to 1 | | Frank Gore | 8 to 1 | | Reggie Wayne | 10 to 1 | |
| Tony Romo | 15 to 1 | | Reggie Bush | 12 to 1 | | Hakeem Nicks | 10 to 1 | |
| Joe Flacco | 15 to 1 | | Chris Ivory | 12 to 1 | | Jordy Nelson | 10 to 1 | |
| Andy Dalton | 15 to 1 | | Darren Sproles | 12 to 1 | | Mike Wallace | 12 to 1 | |
| Matt Ryan | 15 to 1 | | Montee Ball | 12 to 1 | | Pierre Garcon | 12 to 1 | ✓ |
| Eli Manning | 15 to 1 | | Ryan Mathews | 12 to 1 | | Eric Decker | 12 to 1 | |
| Russell Wilson | 15 to 1 | | Lamar Miller | 12 to 1 | | Wes Welker | 12 to 1 | |
| Matt Schaub | 15 to 1 | | Mikel Leshoure | 12 to 1 | | Steve Smith | 12 to 1 | |
| Carson Palmer | 15 to 1 | | Vick Ballard | 12 to 1 | | Dwayne Bowe | 12 to 1 | |
| Dennis Dixon | 20 to 1 | | Eddie Lacy | 12 to 1 | | Torrey Smith | 12 to 1 | |
| Geno Smith | 20 to 1 | | Mark Ingram | 12 to 1 | | Greg Jennings | 12 to 1 | |
| | | | Fred Jackson | 12 to 1 | | Cecil Shorts | 12 to 1 | |
| | | | Ryan Williams | 15 to 1 | | Steve Johnson | 12 to 1 | |
| | | | Michael Turner | 15 to 1 | | Antonio Brown | 12 to 1 | |
| | | | Michael Bush | 15 to 1 | | Miles Austin | 12 to 1 | |
| | | | Steven Jackson | 20 to 1 | | Mike Williams | 12 to 1 | |
| | | | Ben Tate | 20 to 1 | | Josh Gordon | 12 to 1 | |
| | | | Isaiah Pead | 25 to 1 | | DeSean Jackson | 12 to 1 | |
| | | | | | | Jeremy Maclin | 15 to 1 | |
| | | | | | | T. Y. Hilton | 15 to 1 | |

Bet Type: 3 Person Parlay
Wager: $1
Sport: Football
Time Period: Week 3
Payout: 3 of 3 = $720
Choose one player from each category ✓

In this embodiment, the game is played exactly the same as described above in the preferred embodiment. However, in this embodiment the payout varies depending upon the player picked. For example, two people filled out Fantasy Parlay Card 2 and they are identical except that one picked Mike Vick as a quarterback and the other picked Geno Smith. According to the odds, Vick is much more likely to score the most quarterback points than Smith. Because of these odds, if the player who selected Smith wins the wager, her payout will be significantly larger than it would have been had she selected Vick and won. Although the above description references a sports league, the fantasy gaming system of the instant invention would also apply equally to any group of sports participants regardless of whether referred to as a league. For example, the fantasy game could use people competing in the Olympics, Oscars, or Reality TV shows. An additional example would be to use objects such as stocks, bonds, or commodities.

While preferred embodiments of this invention have been shown and described above, it will be apparent to those skilled in the art that various modifications may be made in these embodiments without departing from the spirit of the present invention. That is, the device could be used for a wide variety of purposes either in combination or separately.

We claim:

1. A fantasy gaming system or method applied to players in a team sport in which players may be identified by position and in which the performance of players may be easily measured comprising:
(1) a table is established which sets out the manner in which the performance of players in each position is determined and a number score assigned;
(2) a user selects at least one player in each of at least two different positions where such players are expected to play a game at a known time in the future;
(3) the user wagers on the performance of the players selected;
(4) after the games take place, the performance of all players is determined and a number score assigned to each player;
(5) if the players selected by the user scored the highest at their position, the user wins and is paid an amount based upon the odds against winning at the selected positions.

2. The fantasy gaming system or method of claim 1 in which a user may win even if not all players were the highest scoring at their position.

3. A fantasy gaming system or method applied to players in a team sport in which players may be identified by position and in which the performance of players may be easily measured comprising:
(1) a table is established which sets out the manner in which the performance of players in each position is determined and a number score assigned;
(2) a payout table is established which sets out the odds of each player receiving the highest number score in each position and establishes a payout for each player;
(3) a user selects at least one player in each of at least two different positions where such players are expected to play a game at a known time in the future;
(4) the user wagers on the performance of the players selected;
(5) after the games take place, the performance of all players is determined and a number score assigned to each player;
(6) if the players selected by the user scored the highest at their position, the user wins and is paid an amount based upon the odds against winning at the selected positions as set out in the payout table.

4. The fantasy gaming system or method of claim 3 in which a user may win even if not all players were the highest scoring at their position.

5. The fantasy gaming system or method of claim 1 applied to activities based upon actions or occurrences which happen in the real world other than team sports.

6. The fantasy gaming system or method of claim 1 applied to a combination of different team sports or other activities based upon actions or occurrences which happen in the real world.

7. The fantasy gaming system or method of claim 3 applied to activities based upon actions or occurrences which happen in the real world other than team sports.

8. The fantasy gaming system or method of claim 3 applied to a combination of different team sports or other activities based upon actions or occurrences which happen in the real world.
